(19) United States
(12) Patent Application Publication
(10) Pub. No.: US 2012/0305331 A1
(43) Pub. Date: Dec. 6, 2012

(54) SERVICE PLATFORM

(75) Inventor: Anthony Rowell, Leicestershire (GB)

(73) Assignee: EXTREME ACCESS HIRE LIMITED, Leicester (GB)

(21) Appl. No.: 13/579,134

(22) PCT Filed: Feb. 16, 2011
(86) PCT No.: PCT/GB2011/050301

§ 371 Date: Aug. 15, 2012

(30) Foreign Application Priority Data
Feb. 16, 2010 (GB) 1002581.5

(51) Int. Cl. B08B 1/00; B66F 11/04; F03D 11/00; A46B 15/00; B08B 1/04

(52) U.S. Cl. 182/18; 15/4; 182/129; 182/51; 182/63.1

(57) ABSTRACT

A service platform (1), typically for servicing (including cleaning) wind turbine blades (200), comprising a cradle (2) having at least one mounting point (6) by means of which the cradle (2) can be lifted, and a plurality of elongate brushes (3) mounted from the cradle (2) so as to extend vertically from the cradle (2) when the service platform (1) is lifted using the or each mounting point (6). Typically, the service platform (1) will be lifted on an extendable boom (100).

This invention relates to service platforms, such as may non-exclusively be employed to service wind turbine blades in situ.

Given a desire to reduce society's reliance on fossil fuels, renewable energy sources are becoming increasingly popular. In particular, wind turbines are increasingly being deployed in appropriate areas in order to generate electricity from wind. They comprise a set of turbine blades, mounted on a rotatable axle. Wind flow over the turbine blades causes them to rotate the axle, which is coupled to a generator in order to generate electricity.

However, the efficiency of a wind turbine depends on the aerodynamic performance of the turbine blades. Even minor faults, such as cracks or the like, can reduce the “lift” generated by the turbine blade. Furthermore, the blades need to be kept clean; otherwise, the efficiency will similarly decline.

It is presently known to clean and otherwise service wind turbine blades using cradles suspended from cables using cranes. These service platforms, such as that shown in the European Patent Application published as EP 1 517 033, have a pair of generally parallel brushes extending horizontally from a cradle to which a crane's cable can be attached. By positioning the turbine blade vertically, then locating the brushes either side of the turbine blade and raising and lowering the platform, the blades can be cleaned.

However, this is unwieldy, particularly given the height (up to 110 m) of the blades and their length (up to 60 m). Very large cranes need to be employed. Furthermore, because the platform is suspended from cables, controlling the platform from the ground can be inaccurate, particularly given that the cables are attached to the cradle, at one end of the brushes; the weight of the long and heavy brushes cantilevered from the cradle acts as a moment on the cradle, which is difficult to counteract. Wind turbine blades are delicate, and control issues are extremely problematic.

According to a first aspect of the invention, there is provided a service platform, comprising a cradle having at least one mounting point by means of which the cradle can be lifted, and a plurality of elongate brushes mounted from the cradle so as to extend vertically from the cradle when the service platform is lifted using the or each mounting point.

By mounting the brushes generally vertically, the ease of control of the service platform is greatly increased, because the brushes will be cantilevered out from the cradle to a lesser extent than if they were mounted horizontally. This means that brushes will apply less torque on the cradle, and so less torque in turn will need to be applied to the cradle in order to counteract the turning effect of the brushes.

By extending vertically, we include any substantial vertical component in the direction in which the brushes extend. However, in the preferred embodiment the brushes are mounted so as to extend substantially vertical when the service platform is lifted using the or each mounting point. For example, the brushes may be at an angle of less than 45, or 30, or 15, or 5 degrees to vertical. Indeed, the brushes may be vertical when the service platform is lifted using the or each mounting point. The greater degree of verticality, the lower in general the torque acting on the cradle.

The or each mounting point may comprise a hitch for a cable, so that the service platform can be suspended from a crane by cables. However, in the preferred embodiment of the invention, the or each mounting point is a mounting point for a boom, in particular an extendable boom. Accordingly, the inventors have appreciated that extendable booms can be used to support such service platforms (in particular those used for servicing wind turbines); rather than suspending the platform from a flexible cable, the platform can be supported by an extendable boom, which are substantially more rigid. Support with a boom will inherently provide a greater degree of control, and be better able to cope with torques exerted by the cradle, than suspension from cables.

The inventors have recognised that there is a prejudice in the art against the use of booms where heights such as those of wind turbines are involved, not least because booms, and in particular extendable booms of a suitable length are at present uncommon.

The brushes may be arranged to clean an elongate object, such as a wind turbine blade. The brushes may be of the type comprising a plurality of flexible strips extending from a cylindrical body. The strips may be absorbent, and may be formed of textiles or other materials, such as cross-linked polyethylene (PEX) or poly foam material. Such brushes will be familiar from car washes. Rotation of the brushes causes the strips to fly out from the central body, and can then be applied against the object to be cleaned.

Each brush may be mounted on the cradle by means of a brush mounting. Each brush mounting may allow the respective brush to independently move horizontally when the cradle is lifted using the or each mounting point, in one direction or two perpendicular directions, so as to change the spacing of the brushes or their distance from the cradle.

Furthermore, each brush mounting may allow the respective brush to pivot about an axis perpendicular to the length of the brush, so as to change the pitch of the brush. An actuator, such as a hydraulic actuator or an electric motor, may be provided to cause such motion for each degree of freedom discussed above.

Finally, each brush mounting may allow the respective brush to rotate about its length; as is well known, this provides a cleaning action. A drive, such as an electric motor may be provided for the rotation of the brush about its length.

The cradle may provide a platform for a user, such that the user may occupy the platform when the cradle is lifted by the or each mounting point. The platform may comprise a floor, which may be substantially horizontal when the cradle is lifted by the or each mounting point. A barrier may surround the floor in order to prevent falls. Having a user in the cradle whilst the service platform is in use is advantageous, as it allows the user to determine at close quarters what control needs to be exerted over the service platform. A user on the ground would have difficult in knowing as accurately what control is needed. The cradle may therefore be provided with at least one control unit, which is arranged to allow the user to control one or more functions of the service platform from the cradle in use of the service platform.

The cradle may be provided with testing means, by means of which the condition of an object, such as a wind turbine blade, can be investigated. As such, the testing means may comprise a video camera, or an ultrasound imaging device. Feedback means, such as a video monitor, may be provided in the cradle, such that a user may determine the condition of the blade immediately local to the object, and then make any further investigations, servicing actions or repairs that might be necessary whilst adjacent to the object, thus reducing the need to disturb the object; for a wind turbine, this may reduce the need to remove wind turbine blades which is a costly and possibly dangerous exercise. By not having to remove wind turbine blades as frequently, downtime for the wind turbine can also be reduced.

The cradle may also be provided for means for applying substances to the object to be serviced. For example, a cleaning fluid, such as water or water with detergent, may be applied, or a solution to seal the surface of a wind turbine blade or the like. Where a user occupies the platform, more accurate application of such substances may be possible.

Preferably, the service platform is a service platform for servicing wind turbine blades. The servicing may comprise cleaning the blades.

According to a second aspect of the invention, there is provided a combination of the service platform of the first aspect of the invention, and a boom, the boom connected to and supporting the service platform by means of the or each mounting point.

As discussed above, this provides a more convenient and accurately controllable alternative to suspension of the service platform from the cable of a crane. Given that the service platform can be more accurately controlled, the servicing actions may be able to be carried out much quicker.

The boom may be an extendable boom. In order to reach typical wind turbines, the boom should be able to reach a length of at least 75 metres, and preferably 100 or 110 metres.

According to a third aspect of the invention, there is provided the use of the service platform of the first aspect of the invention or the combination of the second aspect of the invention in servicing a wind turbine blade.

Such servicing will typically be carried out with the turbine blade attached to a wind turbine—the servicing is in situ. Preferably, the servicing comprises cleaning the turbine blade.

There now follows, by way of example only, an embodiment of the present invention, described with reference to the accompanying drawings, in which:

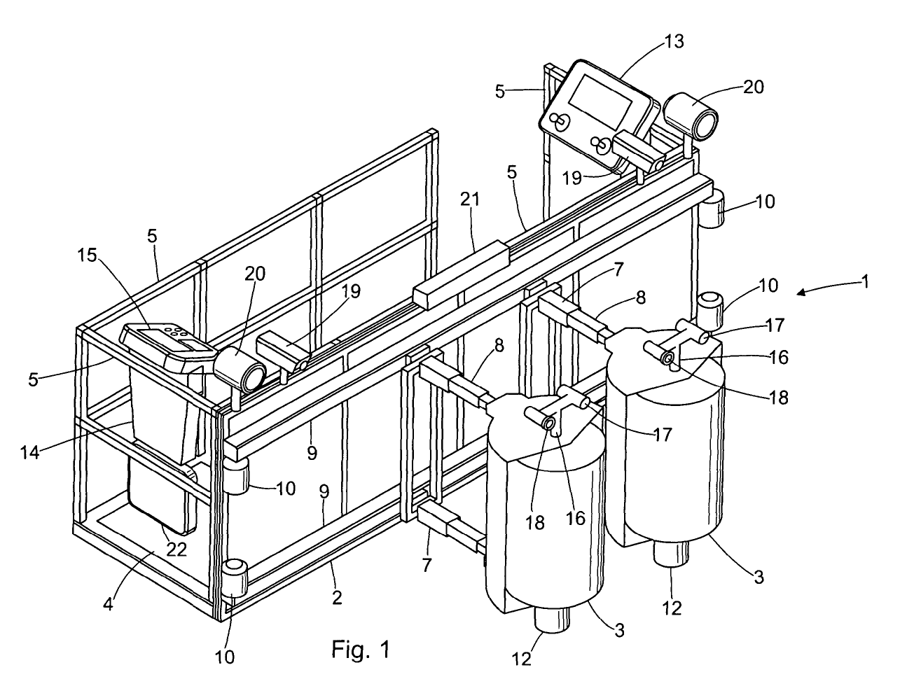

FIG. 1 shows a perspective view of a wind turbine service platform according to an embodiment of the invention;

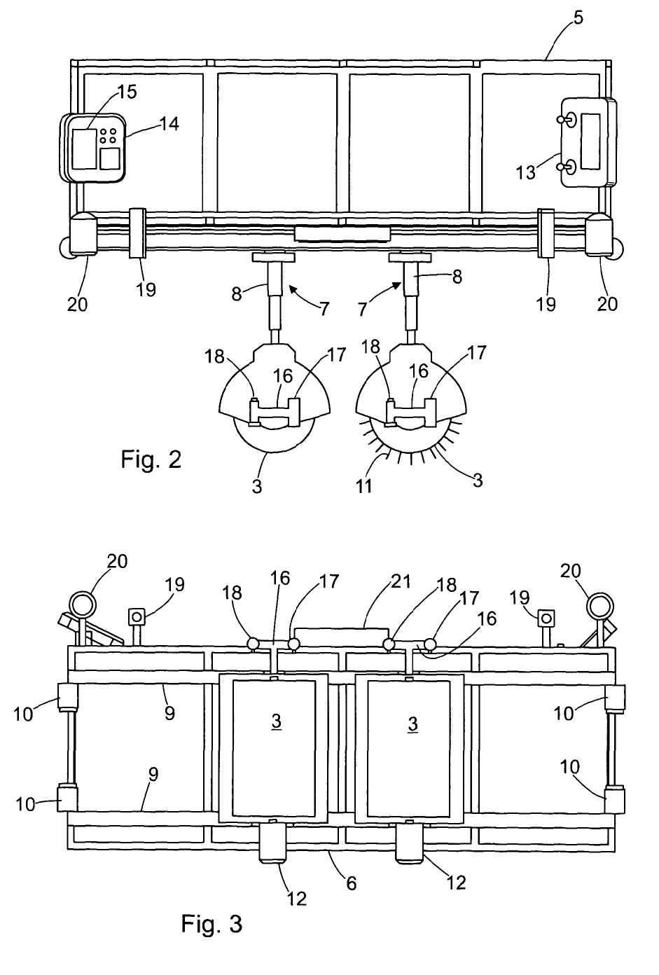

FIG. 2 shows a plan view of the wind turbine service platform of FIG. 1;

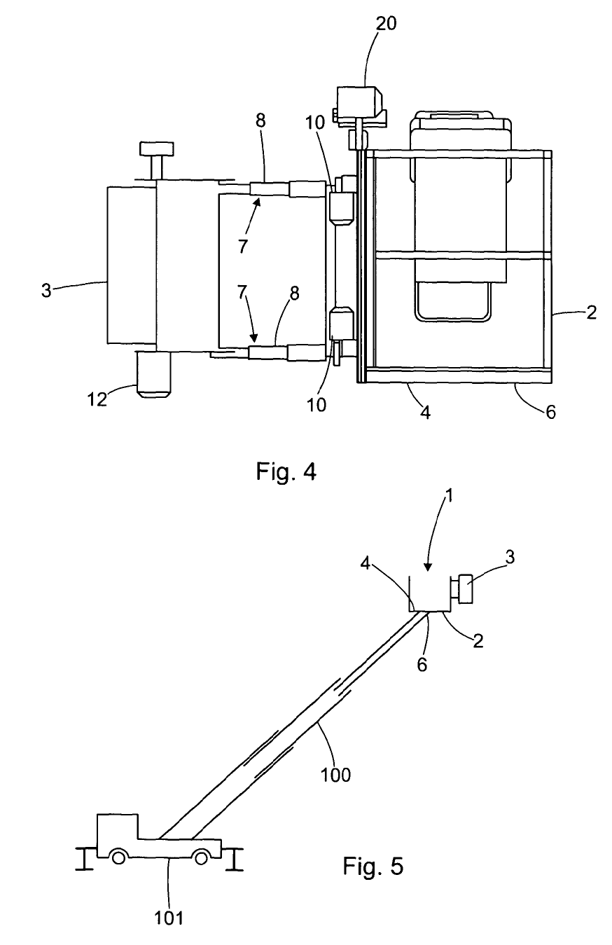

FIGS. 3 and 4 show side and front elevations of the wind turbine service platform of FIG. 1;

FIG. 5 shows the wind turbine service platform of FIG. 1, supported by an extendable boom;

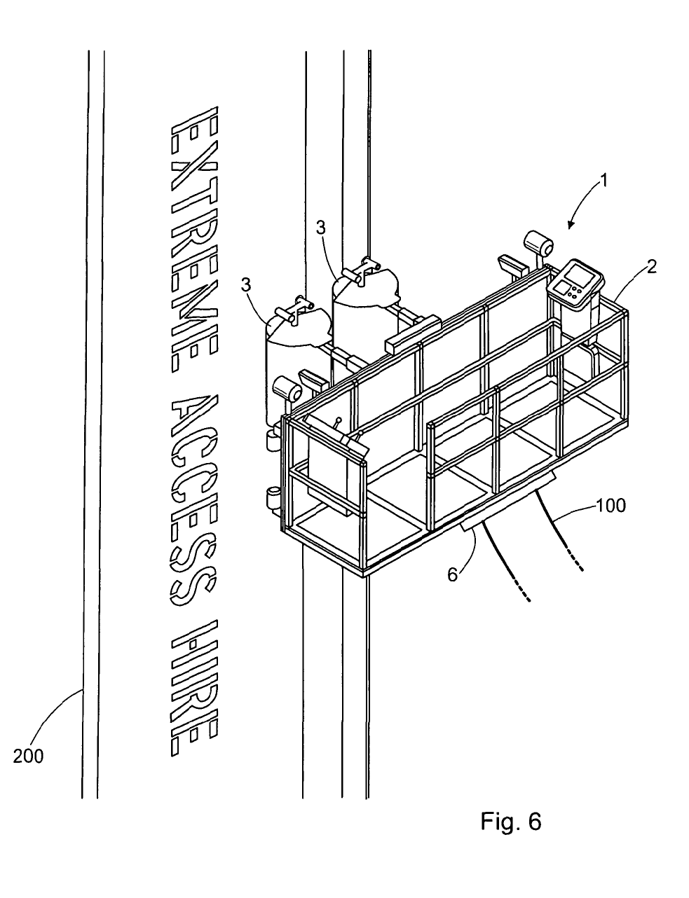

FIG. 6 shows the wind turbine service platform of FIG. 1 being used to service a wind turbine.

The accompanying figures show a wind turbine service platform 1 according to an aspect of the invention. This comprises a cradle 2 from which two brushes 3 are mounted. The brushes 3 are mounted on the cradle 2 vertically. This means that a lower torque is exerted on the cradle 3 by the brushes than would be the case if the brushes 3 were mounted horizontally cantilevered outwards from the cradle 2.

The cradle 2 comprises a platform 4 on which a user can stand whilst the servicing platform is being used. The platform 4 is surrounded by guard rails 5 to prevent the user from falling off.

Part of the platform, shown at 6, also forms a mounting point for an extendable boom 100. The boom 100 is a telescopic arm mounted on a base 101, which doubles as a transport vehicle. The length of the boom 100 can be varied, and the zenith and azimuth of the boom varied by rotating the boom about its mounting to the base 101. Thus, the boom can generally be moved almost anywhere within a hemisphere above the base, with a radius of the maximum length of the boom 100.

The service platform 1 is mounted on the boom 100 such that the floor 4 is horizontal. This allows a user to stand on the floor in use. Because the service platform 1 is being supported by a generally rigid boom 100, rather than being suspended from cables, it is much less likely to suffer sudden unexpected movements. Cable-mounted platforms can move in such an unpredictable manner that to date it has not been desired to have a user on the platform in use, for safety's sake particularly in the high wind environments that wind turbines are generally situated in.

Each brush 3 is mounted on the cradle 2 by means of a mount 7. Each mount 7 comprises a pair of telescopic arms 8, which allow the distance of the brushes relative to the cradle to be controlled. The mounts 7 are mounted on a pair of horizontal rails 9 on the cradle, the rails 9 being vertically spaced parallel to each other. The mounts can run along the rails 9 in a horizontal direction under the power of motors 10, which allow the lateral position of the brushes relative to each other and the cradle 2 to be controlled. Finally, the mounts 7 can pivot about a vertical axis relative to the cradle where they are mounted onto the rails 9. This allows the angle of the brushes 3 relative to the cradle 2 to be controlled.

Each of the brushes is of similar form to those commonly employed in car washes. As shown schematically with respect to the right-hand brush 2 in FIG. 2 of the accompanying drawings, they comprise a plurality of strips 11 mounted onto a cylindrical core. By rotating the core (using motor 12, the strips will rotate, and will be flung outwards against whatever happens to be adjacent to them.

The cradle 2 is provided with two control units 13, 14. The first control unit 13 controls the functions of the boom 100, and thus can be used to manoeuvre the cradle into an appropriate position. The second control unit 14 controls the functions of the cradle, such as the position and speed of the brushes and any other of the functions described below. It can also provide feedback to a user by means of video display 15.

Each of the brushes 3 is provided with a head portion 16, which has two main functions. Firstly, it contains a proximity sensor 17, which senses how far the brush is from the surface it is cleaning. This is particularly important with delicate wind turbine blades, as it allows a check to be made that the rigid parts of the platform are not about to be in collision with the blade. This proximity sensor may be coupled to either of the first 13 or second 14 control units so that either the brush or the platform itself can be moved away from the turbine blade should a brush 3 get too close to the blade.

Secondly, the head portion 16 has a jet 18, which allows water, a water/detergent mixture, or any other liquid to be sprayed onto a wind turbine blade.

The cradle is also provided with video cameras 19, by means of which images can be captured of the condition of a turbine blade. These can be displayed to the user via video screen 15, or relayed elsewhere or recorded. Lights 20 are provided to illuminate the blade to ensure good picture quality, and to improve the view a user has of the blade.

The cradle is further provided with a non-destructive testing module 21. This images the surface, and preferably at least part of the interior of the blade being serviced. Typically, this would employ ultrasound scanning of the blade, which is well known for testing blades once they have been removed from a turbine, but which does not appear to be used with the blades in situ. As a user will be present in the cradle 2 when the testing is carried out, the testing process will be much more easily carried out for a blade in situ than it otherwise would be.

A programmable logic controller (PLC) 22 is also provided, which acts on the instructions of the second control panel 14 to control the functions of the service platform and the boom. It can therefore be seen that much processing can be carried out in the immediate vicinity of a blade mounted to a turbine, without having to disturb the mounting of the blade in the turbine.

The wind turbine service platform 1 can be seen in use in FIG. 6 of the accompanying drawings. It can be seen adjacent to a wind turbine blade 200, which has been locked in a vertical position depending downwards from the axle about which it would normally rotate. By using the boom 100 to bring the platform 1 roughly adjacent to the blade 200, the brush mounts 7 can be used to position the brushes 3 at an appropriate position and angle of attack. The boom 100 can be used to move the service platform 1 vertically along the length of the turbine blade, under the control of a user standing in the cradle 2. By appropriately positioning the cradle and the blade, and also changing the pitch of the blade (that is, rotating it about its length) it is possible to clean or otherwise service an entire blade quickly and flexibly.

1. A service platform, comprising:
a cradle having at least one mounting point by means of which the cradle can be lifted; and
a plurality of elongate brushes mounted from the cradle so as to extend vertically from the cradle when the service platform is lifted using the at least one mounting point,
wherein the cradle includes a platform for a user, the platform having a floor which is substantially horizontal when the cradle is lifted by the at least one mounting point.

2. (canceled)

3. The service platform of claim 1, wherein the at least one mounting point is a mounting point for a boom, in particular an extendable boom.

4. The service platform of claim 1, wherein the brushes are arranged to clean an elongate object, such as a wind turbine blade.

5. The service platform of claim 1, wherein each brush is mounted on the cradle by means of a brush mounting which allows the respective brush to independently move horizontally when the cradle is lifted using the at least one mounting point, in one direction or two perpendicular directions, so as to change the spacing of the brushes or their distance from the cradle.

6. The service platform of claim 5, wherein each brush mounting allows the respective brush to pivot about an axis perpendicular to the length of the brush, so as to change the pitch of the brush.

7. (canceled)

8. The service platform of claim 1, wherein the cradle is provided with at least one control unit, which is arranged to allow a user to control one or more functions of the service platform from the cradle in use of the service platform.

9. The service platform of claim 1, wherein the cradle is provided with testing means, by means of which the condition of a wind turbine blade can be investigated.

10. The service platform of claim 9, further comprising:
feedback means, such as a video monitor, in the cradle, such that a user may determine the condition of the blade immediately local to the object.

11. The service platform of claim 1, wherein the cradle is provided with means for applying substances to the object to be serviced.

12. A combination comprising:
a service platform, including a cradle having at least one mounting point by means of which the cradle can be lifted; and
a plurality of elongate brushes mounted from the cradle so as to extend vertically from the cradle when the service platform is lifted using the at least one mounting point, wherein the cradle includes a platform for a user, the platform having a floor which is substantially horizontal when the cradle is lifted by the at least one mounting point; and
a boom,
wherein the boom is connected to and supports the service platform by means of the at least one mounting point.

13. The combination of claim 12, wherein the boom is an extendable boom, capable of reaching a length of at least 75 metres, and preferably 100 or 110 metres.

14. A method of servicing a wind turbine blade, the method comprising:
using a service platform, including a cradle having at least one mounting point by means of which the cradle can be lifted, and a plurality of elongate brushes mounted from the cradle, wherein the cradle includes a platform for a user, the platform having a floor;
lifting the service platform from the at least one mounting point so that the brushes extend vertically from the cradle, and so that the floor is substantially horizontal; and
using the service platform once elevated to service the wind turbine blade.

15. The method of claim 14, wherein the servicing is carried out with the turbine blade attached to a wind turbine.

16. The method of claim 14, wherein a boom is connected to and supports the service platform by means of the at least one mounting point.
